(19) United States
(12) Patent Application Publication
(10) Pub. No.: US 2008/0145197 A1
(43) Pub. Date: Jun. 19, 2008

(54) Roller rack

(76) Inventors: Harry Randall Taylor, Whittier, CA (US); Dan Aurel David, La Canada Flintridge, CA (US)

Correspondence Address: CHRISTIE, PARKER & HALE, LLP, PO BOX 7068, PASADENA, CA, 91109-7068, US

(21) Appl. No.: 11/639,525

(22) Filed: Dec. 15, 2006

(51) Int. Cl. B65G 1/00

(52) U.S. Cl. 414/276

(57) ABSTRACT

A boltless roller rack is provided having upright corner support posts and one or more shelves. At least one shelf comprises front and rear cross-beams and at least one roller section. The front and rear cross-beams extend between and are secured to the front and rear corner support posts respectively. Each of the front and rear cross-beams has an inwardly facing channel which securely receives the front and back end of the roller sections. The front cross beam further provides a surface for engaging articles moving forwardly over the roller section and impeding their further forward movement.

### BACKGROUND OF THE INVENTION

Roller racks including corner support posts and one or more shelves or “tiers” of rollers are known. In such roller racks, a plurality of elongated rollers are rotatably mounted in supporting frames to form roller panels or sections. The roller sections are mounted on horizontal support bars, e.g., cross-beams that extend between the corner support posts Typically the roller sections are mounted such that there is an downward incline from the back to the front. As a result of the incline, items placed on the roller sections move forwardly over the rollers due to the effect of gravity.

To keep the roller sections in position on the support bars, roller racks have employed a variety of systems. For example, U.S. Pat. No. 5,951,228 discloses a system for positioning a roller section, referred to as a “flow track,” on front and rear support bars. The system includes retainer bars, having a plurality of teeth, that are attached to the support bars. The rails of the flow track frame are received in the wells between the teeth. Flanges on the teeth and a locking pin keep the flow track locked in position. Such complex systems increase the cost of manufacture as well as the time and cost of assembly.

There is a need for a roller rack having a simplified and economical system for mounting roller sections to horizontal supports.

### SUMMARY OF THE INVENTION

The invention provides a roller rack comprising upright front and rear support posts and one or more shelves or tiers. Each shelf or tier comprises generally horizontal front and rear cross-beams mounted on the front and rear support posts respectively and at least one roller section extending from the front cross-beam to the rear cross-beam. The roller sections receive and convey articles placed thereon.

The front and rear cross-beams have a cross-sectional configuration that forms an inwardly facing channel i.e., a channel having an opening facing the interior of the rack, for receiving the front and rear ends of the roller sections. The minimum width of the channel, e.g., at its opening, is selected to be slightly larger than the thickness of the roller section. The front and rear cross-beams support the ends of the roller sections and prevent dislodging of the roller sections from the cross-beams. Preferably the cross-sectional configuration of the front and rear cross-beams are the same.

Each roller section comprises a frame including generally parallel, spaced apart side supports and a plurality of free turning rollers rotatably mounted at their ends to the side supports. The front end of the roller sections is disposed in the channel of the front cross-beam and the rear end of the roller section is disposed in the channel of the rear cross-beam.

The front and rear cross-beams may be mounted on the support posts at the same elevation so that the roller sections are in a generally horizontal plane. More preferably, however, the rear cross-beam is mounted on the rear support posts at a slightly higher elevation than the elevation of the front cross-beam. This provides the roller section with a slight downward pitch from back to front. In this arrangement, articles placed on the rearward portion of a roller section will, due to gravity, move toward the front of the roller section. Preferably, the pitch of the roller sections is adjustable.

In a particularly preferred embodiment, the front cross-beam is configured to provide a stop, i.e., a surface that engages articles on a roller section that are moving forwardly, thus preventing the articles from falling off the rack.

The shelves may also comprise right and left side stabilizer beams which extend from the right and left front support posts to the rear right and left rear support posts respectively. If side stabilizer beams are present, the shelf may also comprise one or more center supports. Center supports are supported at their ends by the side stabilizer beams and extends just below the roller sections of the shelf and help to support the roller sections.

The storage rack is preferably of a boltless constructional and may be stationary or movable on rollers. In a preferred boltless construction, the ends of the cross-beams comprise rivets, tabs or the like that are inserted into and secured in slots located in the support posts. In a particularly preferred construction, the support posts comprises keyhole-shaped slots into which rivets, that extend outwardly from the ends of the cross beams, are introduced. The keyhole slots are preferably vertically spaced-apart by about one to about three inches. More particularly, the rivets are introduced into the upper circular portion of the key hole slots and then securely seated into the narrower lower slot portion of the keyhole slot. It is understood that the invention described herein may also be used in racks where the cross-beams are secured to the support posts by screws, bolts and the like or even by more permanent means, e.g., welding.

The dimensions of the rack as well as the number and spacing of the shelves is a matter of choice. The length of the roller sections is selected to extend from the channel in the front cross-beam to the channel in the rear cross-beam. The thickness of the ends of the roller sections must be less than the minimum width of the channels in the front and rear cross-beams so that the ends of the roller sections fit into the channels. Preferably the thickness of the roller sections and the width of the channels are selected to enable the roller sections to be easily inserted into the channels while still minimizing vertical play within the channels.

The roller rack may comprise one or more solid shelf extending forwardly from the rack to provide a work surface, to rest an article, e.g., a package, removed from the rack, the solid shelf may be fixed in place, hinged or slidably retractable, all of which are well known in the art, and may be permanently or removeably attached to the rack frame. The roller rack may also comprise one or more lights to light the work surface.

### BRIEF DESCRIPTION OF THE DRAWINGS

The figures attached hereto show the following:

FIG. 1 is a perspective view of a roller rack according to an exemplary embodiment of the present invention.

FIG. 2 is a perspective view of a roller rack according to another exemplary embodiment of the present invention.

FIG. 3 is a perspective view of a roller rack according to yet another exemplary embodiment of the present invention.

FIG. 4 is a perspective view of the exemplary embodiment of FIG. 3, including close-up views of a preferred mounting means for exemplary upper and lower shelves are of preferred mobile dolly caster.

FIG. 5 is a perspective view of a preferred mobile dolly.

FIG. 6 is a side cross-sectional view of a cross beam and how the cross beam channel is secured to a cross-sectional support post.

FIG. 7a is a perspective view of an end of a preferred center support.

FIG. 7b is a side view in an exemplary embodiment showing how a center support may be slid into position to support a roller section.

FIGS. 8a, 8b, and 8c are three figures showing a side view showing how a roller section is positioned in the cross beam channel.

FIG. 9a-e are cross-sectional views of alternative configurations of suitable front and/or rear cross beams.

FIG. 10 is a cross-sectional view of another preferred support post that hides the keyhole slots.

### DETAILED DESCRIPTION OF THE INVENTION

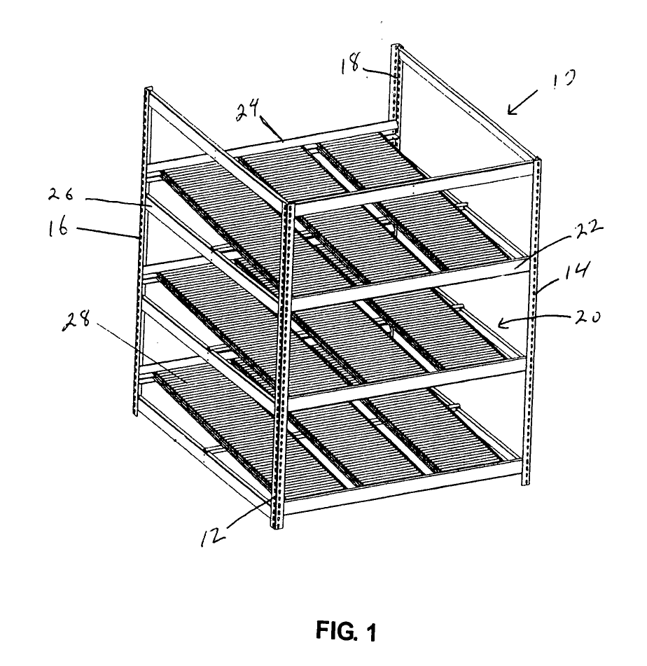

FIG. 1 shows a boltless, adjustable roller rack 10 according to an exemplary embodiment of the present invention. The storage rack includes left and right front upright support posts 12, 14, and left and right rear upright support posts 16, 18. The roller rack 10 further includes one or more shelves or tiers 20. Each shelf or tier 20 comprises a front cross-beam 22, a rear cross-beam 24 and a pair of side stabilizing beams 26. Each shelf or tier 20 also includes one or more roller sections 28, each roller section 28 being supported at its front and back ends by the front and rear cross beams 22 and 24.

The front cross-beams 22 extend laterally between the left and right front upright support posts 12 and 14 and the rear cross-beams 24 extend laterally between the left and right rear upright support posts 16 and 18. The cross-beams 22 and 24 are vertically spaced according to the desired space between shelves 20 of the roller rack 10.

The support posts 12, 14, 16 and 18 are preferably formed out of cold roll steel and preferably have a thickness of from about 20 to about 14 gauge. Greater or lesser thicknesses may be used depending on the load, i.e., the weight to be carried by the rack. The front and rear cross-beams are also preferably formed out of cold roll steel and preferably have a thickness of from about 20 to about 14 gauge. Again, greater or lesser thicknesses may be used depending on the load.

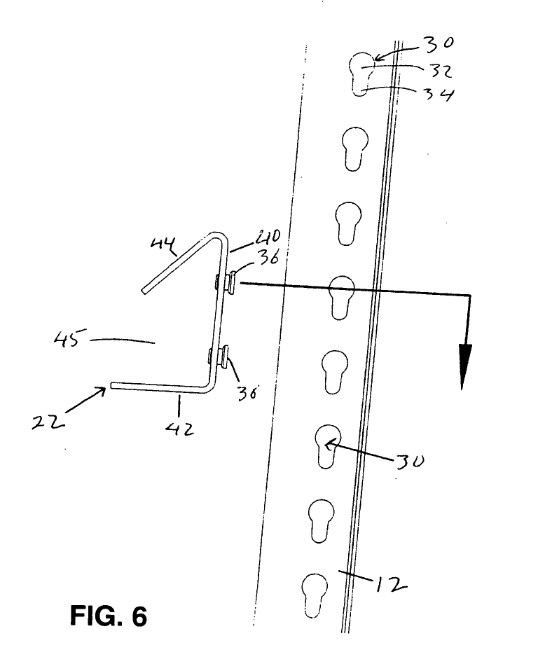

In the preferred embodiment shown, the roller rack 10 is of a boltless construction. With reference to FIG. 6, the upright support posts, e.g., post 12 include keyhole slots 30 having a large, generally circular upper portion 32 and lower, narrower slot portion 34. The keyhole slots 30 are vertically spaced apart, preferably by a distance of about one to about three inches from the vertical mid-point of one slot to the vertical midpoint of an adjacent keyhole slot. The keyhole slots 30 receive and seat rivets 36 at the ends of cross-beams 22 and 24 as described below.

Preferably the front and rear cross-beams 22 and 24 have the same construction. A preferred construction is shown in FIG. 6. The cross-beam comprises a generally vertical outer wall 40, a generally horizontal bottom wall 42 extending inwardly from the lower edge of the outer wall 40, and a top wall 44 extending inwardly and downwardly from the upper edge of the outer wall 40. The top wall 44 and bottom wall 42 wall define an inwardly facing channel 45. The width of the channels 45 of the front and rear cross-beams 22 and 24 are slightly greater than the thickness of the roller sections 28 so that the channels may receive an end of the roller section 28.

At each end, the cross-beams 22 and 24 have a pair of anchoring rivets 36 extending outwardly from the outer wall 40. The rivets 36 includes a shaft preferably cylindrical, and an enlarged head, preferably circular, at the end of the shaft remote from the outer wall 40 for engagement with the keyhole slots 30 of the upright support posts. The diameter and length of the rivet shaft are selected to be slightly less than the width and thickness of the lower slot portion 34 of a keyhole slot 30. The diameter of the head portion of the rivet 36 is less than that of the upper portion 32 of the keyhole slot 30, but greater than the width of the lower slot portion 34. While a pair of rivets at each end of the cross-beams is preferred, it is understood that the cross-beams may include only one rivet on each end, if desired

With reference to FIG. 6, the cross-beams 22 and 24 are anchored to the upright supports 12, 14, 16, and 18 by passing the head of rivet 36 through the large upper portion 32 of a keyhole slot 30 and lowering the cross-beam and rivet 36 until the shaft of the rivet 36 seats in the lower slot portion 32 of the keyhole 30. In this arrangement, the end of the outer wall of the cross beams 22 and 24 engages the inner surface of the upright support posts, e.g. post 12, and the head of the rivet 36 engages the outer surface of the upright support post e.g., post 12, when the rivet 36 is seated within the slot portion 34 of the keyhole slot 30 to thereby prevent or at least reduce rotation of the cross-beams 22 and 24.

In the embodiment shown in FIG. 1, each shelf has a pair of side stabilizing beams 26 extending between the left front and rear upright support posts 12 and 16 and the right front and rear support posts 14 and 18. The side stabilizing beams 26 comprise an generally vertical outer wall 46 and a generally horizontal top wall 48 that extends inwardly from the upper edge of the outer wall 46. A pair of anchoring rivets 36 extend outwardly from the outer wall 46 at each end of the side stabilizing beam 26 for engaging slots 30 in the support posts as previously described.

Preferably the front cross-beam 22 is at one elevation and the rear cross-beam 24 is at a slightly higher elevation. In this arrangement, the roller sections 28 are inclined downwardly from back to front. The pitch can be increased or decreased by selecting higher or lower keyhole slots 30 on the support posts to mount the front and/or rear cross-beams 22 and 24. Articles, e.g., containers, which can move easily over the rollers, will move to the front of the roller section due to gravity unless impeded by the presence of other containers on the roller section or until they engage the top wall 44 of the front cross-beam 22. Because of the downward pitch of the roller section 28 and the angle of the top wall 44 of the front cross-beam 22, articles moving forwardly on a roller section 28 will engage the surface of the top wall 44 which prevents the articles from sliding off the front of the rack

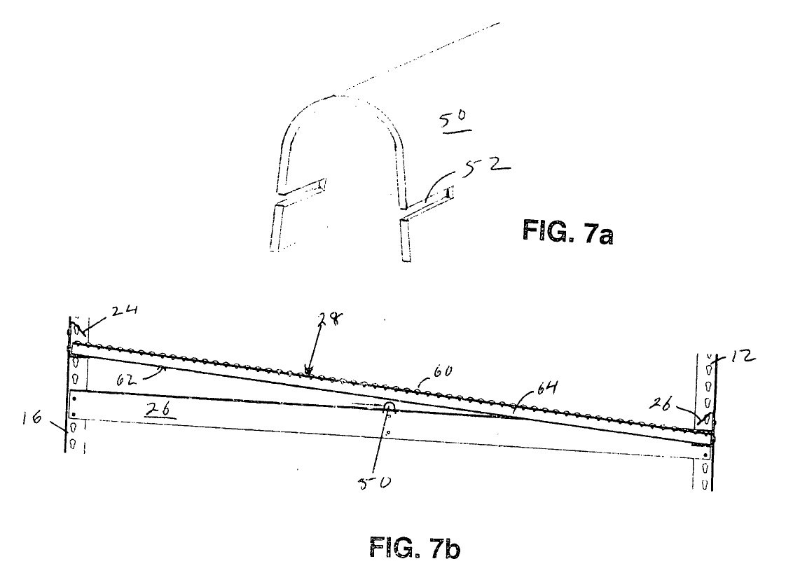

In the preferred embodiment shown in FIG. 1, an additional support is provided for the roller sections 28. This is center support 50 which is mounted at its ends to the side stabilizing beams 26. With reference to FIGS. 7a and 7b, preferred center supports 50 have a generally inverted U-shaped cross-sectional configuration with a slot 52 at each end. The slots 52 receive the inner portions of the top walls 48 of opposing side stabilizing beams 26. In this arrangement, the center support can be slidably positioned along the length of the side stabilizing beams 26 to engage the bottom of the roller sections 28 and thereby assist in supporting the roller sections 28.

Roller sections 28 includes a plurality of spaced-apart rollers 60 rotatably secured at their ends to generally parallel side rails 64 of frame 62. Examples of roller sections having a plurality of spaced apart rollers rotatably secured to side rails can be found in U.S. Pat. Nos. 4,168,780, 6,102,185, 6,132,158, 6,431,808, and 6,497,326, all of which are incorporated by reference. As will be understood by persons of ordinary skill in the art, the number, size (e.g., length and diameter) of the rollers as well as the spacing between rollers may vary.

As shown in FIG. 7b, the forward ends of the roller sections 28 are disposed in the channel 45 of the front cross-beam 22. The back or rearward end of the roller sections 28 are disposed in the channel 45 of the rear cross-beam 24. The width of the roller rack 10 and the length of the roller section is selected so that the roller rack can be mounted in the channels of the front and rear cross-beams as described below.

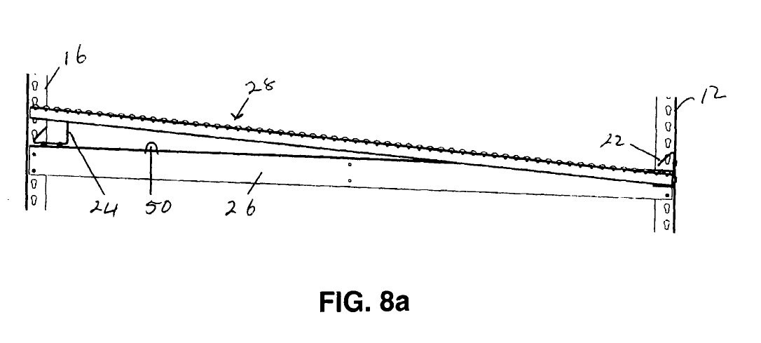

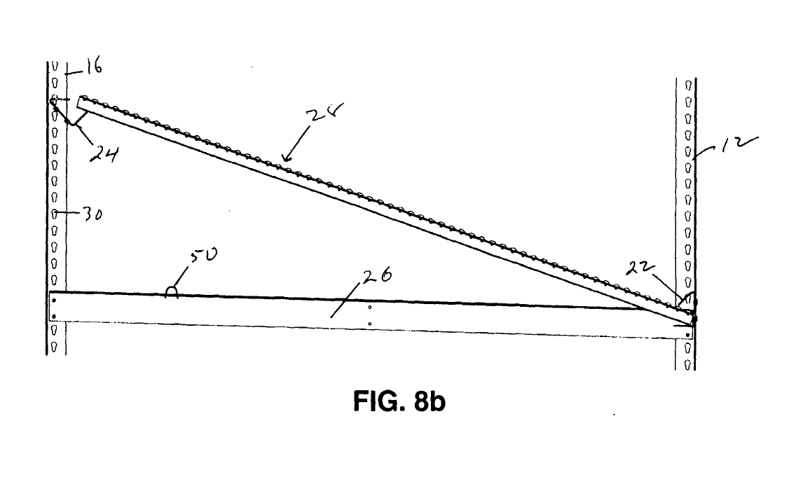

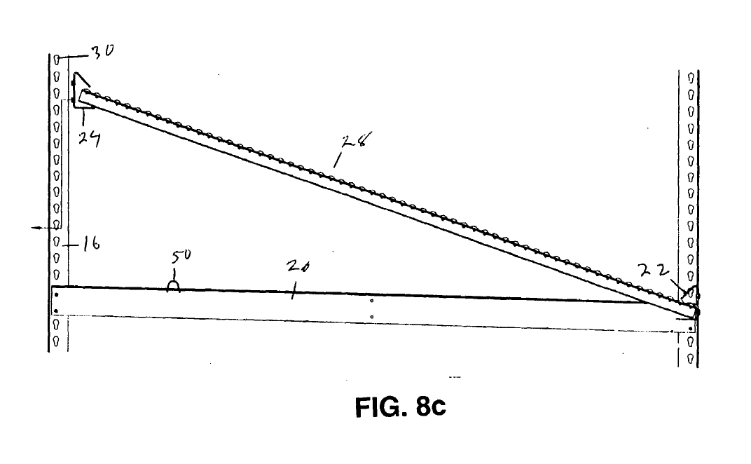

FIGS. 8a-8c show how a roller section 28 is mounted in the front and rear cross-beams 22 and 24. First, as shown in FIG. 8a, the roller section 28 is positioned with its front end inserted into the front cross-beam channel 45 and its back end resting on a rear cross-beam 24 before it is secured to the rear support posts 16 and 18. The rear cross-beam 24 is rotated so that the channel 45 faces upwardly. In FIG. 8a, the rear cross-beam channel is shown with the rivets resting on the top wall of cross beams 26. Next, as shown in FIGS. 8b and 8c, the rear cross beam 24 is lifted and rotated so that the back end of the roller section 28 slides into the rear cross-beam channel 45. Finally, as shown in FIG. 8c, once the back end of the roller section 8 is fully inserted into the rear cross-beam channel 45, the rivets of rear cross-beam 24 are inserted into and seated in the key hole slots, securing the rear cross-beam to the rear support posts 16 and 18.

The roller sections 28 allow for articles such as containers, boxes, bins, or the like to be placed onto a back end of a roller section 28 for sliding to the front end of the roller section 28 by the pull of gravity, thus providing a first-in first-out functionality such that the roller rack 10 may be loaded from the back end, and unloaded from the front end, thereby improving inventory control, improving access efficiency, and reducing traffic at the front end of the adjustable roller rack 10.

The pitch of the roller sections 28 must be adjusted to accommodate different weights of the items placed on the roller sections 28. Heavier items may need less pitch than lighter items in order to slide effectively on the roller sections. Hence, consumers who change the items placed on the roller rack can, if desired, adjust the pitch of the roller sections 28 in order to fully optimize the roller rack.

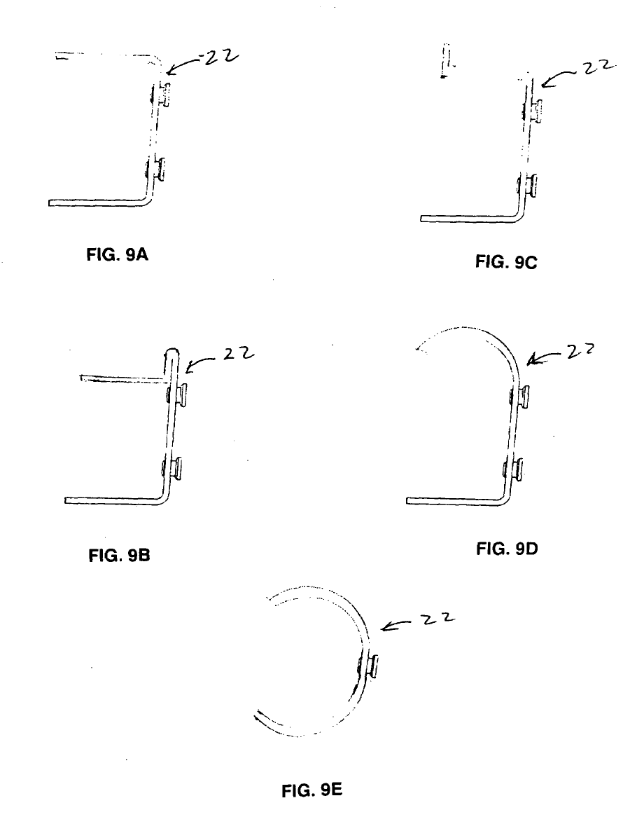

It is understood that a variety of modifications can be made to the storage rack without departing from the scope of the invention. For example, in the embodiment shown in FIG. 1, the front and rear cross beams 22 and 24 have the cross-sectional configuration shown in FIG. 6. Alternative exemplary cross-sectional configurations of suitable front and rear cross beams are shown in FIGS. 9a-9e. While it is preferable that the front and rear cross beams 22 and 24 have the same cross-sectional configuration, which generally minimizes the cost of production, it is understood that the cross-sectional configurations may differ if desired.

It is also understood that, while the preferred side stabilizing beams 26 of the embodiment of FIG. 1 have an inverted “L-shaped” cross-sectional configuration as described above, they may have any suitable cross-sectional configuration, including that of the front and/or rear cross beams. Because the purpose of the side stabilizing beams is to provide stability and support for center supports, any cross-sectional configuration which provides those functions could be used, if desired. Likewise, the cross-sectional configuration of the center support, if present, as well as the manner in which the ends of the center support engage the side stabilizing beams, may vary as desired.

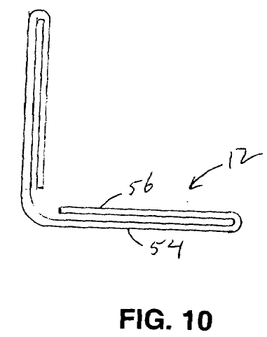

If desired, the keyholes 30 may be hidden. In such an embodiment the upright support posts, e.g., post 12, may be constructed to hide the keyhole slots 30 as shown in FIG. 10. In this embodiment, the exterior walls 54 of the upright support posts double back to form a pair of interior walls 56. The key hole slots 30 are located in these interior walls 56.

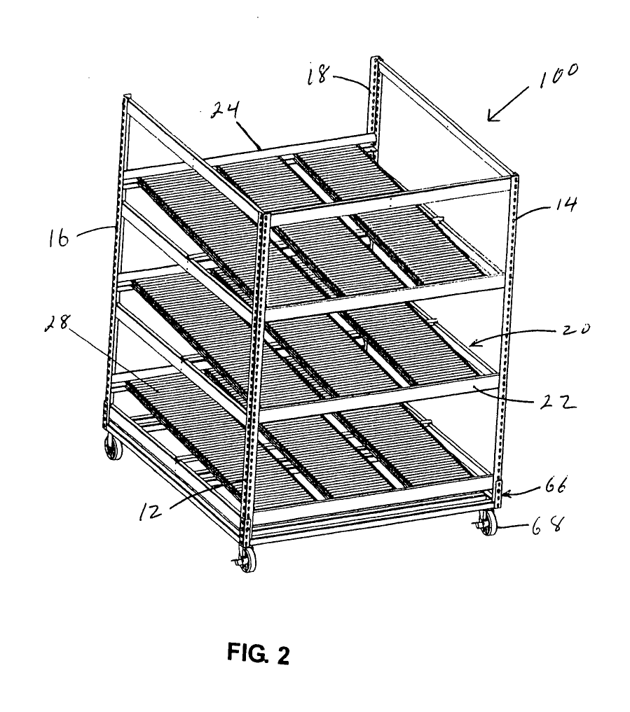

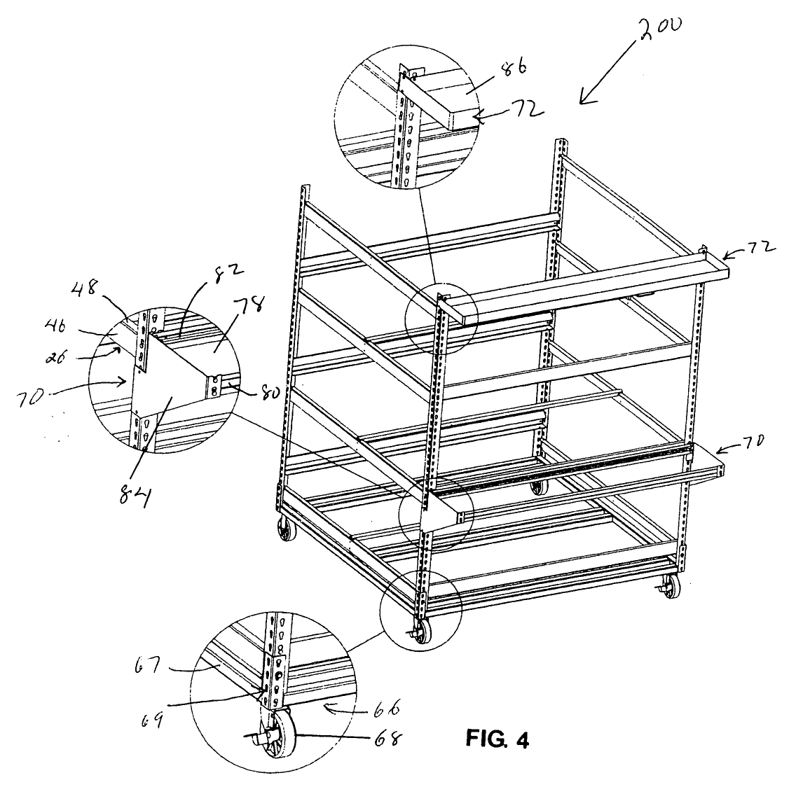

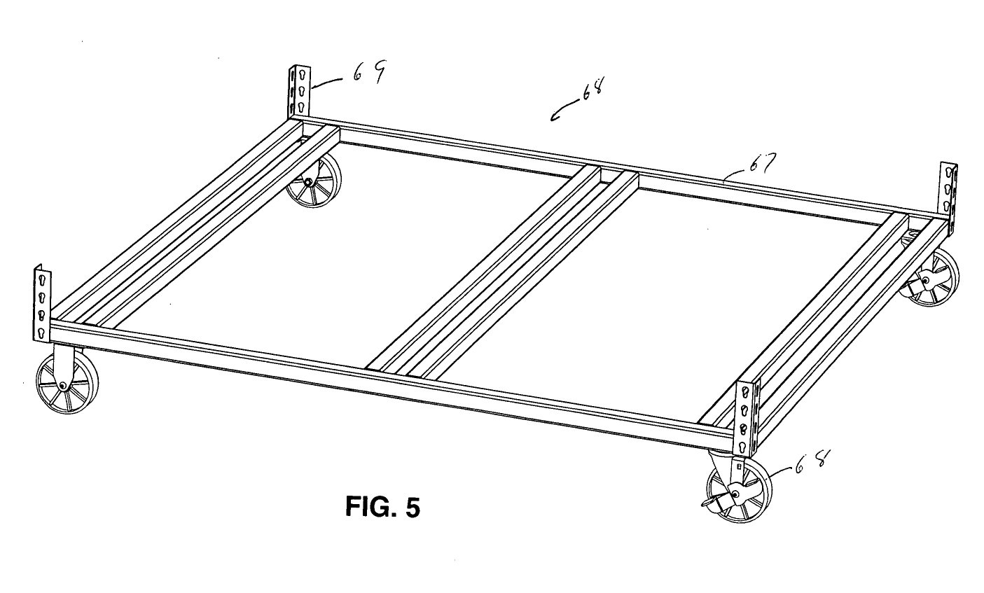

FIG. 2 shows roller rack 100 according to another exemplary embodiment of the present invention. The roller rack 100 includes support posts 12, 14, 16 and 18, front and rear cross-beams 22 and 24, cross-beam channels 45, side stabilizing beams 26, center supports 50, and roller sections 28 as discussed in relation to FIG. 1. In addition, the roller rack 100 includes a mobile dolly 66 attached to the bottom of the roller rack 100 as shown in FIGS. 4 and 5. The mobile dolly 66 includes a frame 67, casters 68 for allowing the roller rack 100 to be moved and upwardly extending brackets 69 for receiving the corner posts of the roller rack. The mobile dolly casters 68 may be of a rigid or swivel type and may include locking mechanisms to lock the caster 68 from swiveling and/or rotating.

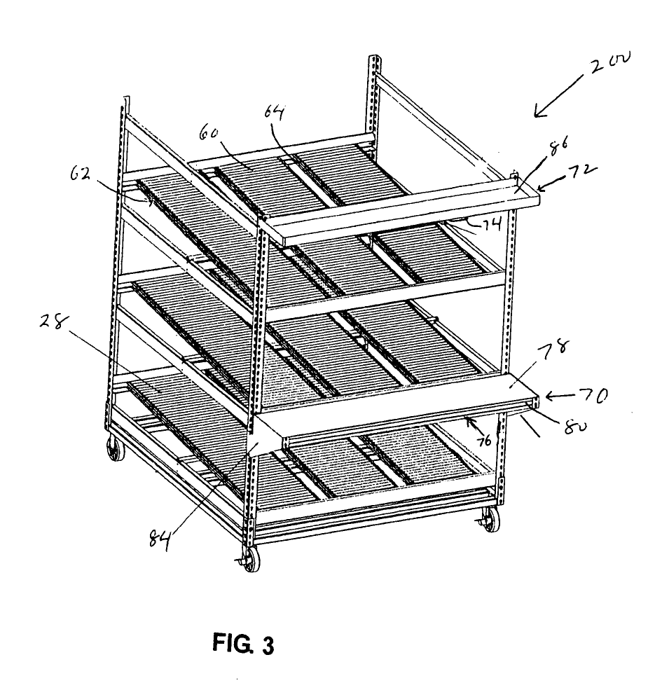

FIGS. 3-5 show a roller rack 200 according to yet another exemplary embodiment of the present invention. Roller rack 200 includes support posts support posts 12, 14, 16 and 18, front and rear cross-beams 22 and 24, cross-beam channels 45, side stabilizing beams 26, center supports 50, and roller sections 28 as discussed in relation to FIG. 1. As shown in FIGS. 4 and 5, the roller rack 200 may also include a mobile dolly 68. With reference to FIGS. 3 and 4, the roller rack 200 may include a solid outwardly extending lower shelf 70 for use as a work surface and an outwardly extending upper shelf 72 for supporting one or more lights 74 to illuminate the work surface of the lower shelf 70.

The lower shelf 70 comprises a generally rectangular frame 76 for supporting a generally flat rectangular panel 78. The panel 78 can be made of any appropriate material. Exemplary materials include wood, including particle board, plastic and metal. The frame 76 includes front and rear support beams 80 and 82. In the embodiment shown, the front and rear support beams 80 and 82 have a Z-style cross-sectional configuration as described, for example, in patent application Ser. No. 60/826,037 filed Sep. 18, 2006, the disclosure of which is incorporated herein by reference. The front and rear support beams 80 and 82 are secured to generally triangular end brackets 84 which in turn are secured to the front support posts 12 and 14. In this embodiment, all connections are boltless and accordingly, the shelf 70 is removable.

It is understood that the lower shelf 70 may simply have a flat panel 78 for use as a working surface that is securely attached to the support posts by fixed or removable brackets. Alternatively, if desired, the shelf panel 78 may be hingedly attached to the support posts 12 and 14 and/or a front cross-beam 22 or retractably mounted to the support posts and/or cross-beam 22 as is well known in the art.

The upper shelf 72, like the lower shelf 70 may be of any appropriate design. The upper shelf 72 is preferably mounted to the front support posts at the top of the rack 200 and includes one or more lights 74 mounted to the bottom side of the shelf panel 86 to illuminate the working surface of the lower panel 78. Any light(s), e.g., incandescent or fluorescent lamp, can be used as desired.

While the invention has been described in its terms of exemplary preferred embodiments, it is to be understood that the words which have been used are words of description and not of limitation. As is understood by persons of ordinary skill in the art, a variety of modifications can be made without departing from the scope of the invention defined by the following claims, which should be given their fullest, fair scope.

What is claimed is:

1. A roller rack comprising:
a pair of front support posts;
a pair of rear support posts;
at least one front cross-beam mounted on and extending between the pair of support posts, said front cross-beam comprising an inwardly facing channel;
at least one rear cross-beam mounted on and extending between the pair of rear support posts, said rear cross-beam comprising an inwardly facing channel;
at least one roller section comprising a plurality of spaced apart rotatable rollers having a forward end disposed within the channel of the front cross-beam and a rearward end disposed within the channel of the rear cross beam.

2. A roller rack as claimed in claim 1 wherein the rear cross-beam is mounted on the rear support posts at an elevation higher than the front cross beam.

3. A roller rack as claimed in claim 1 wherein the front cross-beam comprises a stop to impede forward movement of articles positioned on a roller section.

4. A roller rack as claimed in claim 1 wherein at least one front cross-beam comprises an outer wall, having upper and lower portions, a top wall extending inwardly from the upper portion of the outer wall and a bottom wall extending inwardly from the lower portion of the outer wall.

5. A roller rack as claimed in claim 4 wherein the outer wall is generally vertical and the bottom wall is generally horizontal.

6. A roller rack as claimed in claim 4 wherein the top wall extends downwardly and inwardly from the upper portion of the outer wall.

7. A roller rack as claimed in claim 1 wherein at least one front cross-beam comprises a generally vertical outer wall, having upper and lower edges, a top wall extending downwardly and inwardly from the upper edge of the outer wall and a generally horizontal bottom wall extending inwardly from the lower edge of the outer wall

8. A roller rack as claimed in claim 1 wherein at least one rear cross-beam has the same cross-sectional configuration as a front cross-beam.

9. A roller rack as claimed in claim 1 comprising at least one pair of side stabilizing-beams, each side stabilizing-beam being secured to and extending between a front support post and a rear support post.

10. A roller rack as claimed in claim 9 further comprising a center support supported at each end by a side stabilizing-beam and extending beneath a roller section to assist in supporting the roller section.

11. A roller rack as claimed in claim 9 wherein the side stabilizing beams comprise a generally vertical outer wall having upper and lower edges and a generally horizontal top wall extending inwardly from the top edge of the outer wall.

12. A roller rack as claimed in claim 10 wherein each end of the center support slidably engages and is supported by a side-stabilizing beam.

13. A roller rack as claimed in claim 11 wherein in each end of the center support comprises a generally horizontal slot that slidably engages the generally horizontal top wall of the side stabilizing-beam.

14. A roller rack as claimed in claim 1 wherein the roller rack has a boltless construction.

15. A boltless roller rack comprising:
a pair of front corner support posts;
a pair of rear corner support posts;
at least one shelf comprising
a front cross-beam mounted to and extending between the front corner support posts; said front cross-beam comprising an inwardly facing channel for receiving the rearward end of a roller section;
a rear cross-beam mounted to and extending between the rear corner support posts, said rear cross-beam comprising an inwardly facing channel for receiving the rearward end of a roller section;
at least one roller section having a forward end disposed in the channel of the front cross-beam and a rearward end disposed in the channel of the rear cross-beam.

16. A roller rack as claimed in claim 15 wherein the rear cross-beam is mounted on the rear support posts at an elevation higher than the front cross beam.

17. A roller rack as claimed in claim 15 wherein the front cross-beam comprises a stop to impede forward movement of articles positioned on a roller section.

18. A roller rack as claimed in claim 15 wherein at least one front cross-beam comprises an outer wall, having upper and lower portions, a top wall extending inwardly from the upper portion of the outer wall and a bottom wall extending inwardly from the lower portion of the outer wall.

19. A roller rack as claimed in claim 18 wherein the outer wall is generally vertical and the bottom wall is generally horizontal.

20. A roller rack as claimed in claim 18 wherein the top wall extends downwardly and inwardly from the upper portion of the outer wall.

21. A roller rack as claimed in claim 15 wherein at least one front cross-beam comprises a generally vertical outer wall, having upper and lower edges, a top wall extending downwardly and inwardly from the upper edge of the outer wall and a generally horizontal bottom wall extending inwardly from the lower edge of the outer wall

22. A roller rack as claimed in claim 15 wherein at least one rear cross-beam has the same cross-sectional configuration as a front cross-beam.

23. A roller rack as claimed in claim 15 comprising at least one pair of side stabilizing-beams, each side stabilizing-beam being secured to and extending between a front support post and a rear support post.

24. A roller rack as claimed in claim 23 further comprising a center support supported at each end by a side stabilizing-beam and extending beneath a roller section to assist in supporting the roller section.

25. A roller rack as claimed in claim 23 wherein the side stabilizing beams comprise a generally vertical outer wall having upper and lower edges and a generally horizontal top wall extending inwardly from the top edge of the outer wall.

26. A roller rack as claimed in claim 24 wherein each end of the center support slidably engages and is supported by a side-stabilizing beam.

27. A roller rack as claimed in claim 25 wherein in each end of the center support comprises a generally horizontal slot that slidably engages the generally horizontal top wall of the side stabilizing-beam.

28. A roller rack as claimed in claim 15 further comprising an outwardly extending first shelf having a flat working surface.

29. A roller rack as claimed in claim 28 further comprising an outwardly extending second shelf above the first shelf for supporting at least one light to illuminate the working surface of the first shelf.

30. A roller rack as claimed in claim 15 further comprising a mobile dolly for movably supporting the front and rear corner posts, said dolly having casters below each corner post.

31. A boltless roller rack comprising:
a pair of front corner support posts;
a pair of rear corner support posts; and
a plurality of shelves, each shelf comprising
a front cross-beam mounted to and extending between the front corner support posts; said front cross-beam comprising an inwardly facing channel for receiving the rearward end of a roller section and a stop for impeding forward movement of articles positioned on a roller section;
a rear cross-beam mounted to and extending between the rear corner support posts, said rear cross-beam comprising an inwardly facing channel for receiving the rearward end of a roller section;
a plurality of roller sections, each having a forward end disposed in the channel of the front cross-beam and a rearward end disposed in the channel of the rear cross-beam;
a pair of side stabilizing-beams, each side stabilizing-beam being secured to and extending between a front support post and a rear support post; and
a center support supported at each end by a side stabilizing-beam and extending beneath a roller section to assist in supporting the roller section.
